(19) United States
(12) Patent Application Publication
(10) Pub. No.: US 2014/0117881 A1
(43) Pub. Date: May 1, 2014

(54) SHOE BODY LIGHT-EMITTING DEVICE WITH A PLURALITY OF LIGHT-EMITTING FORMS

(71) Applicant: TERRY ELECTRONCS (S.Z) CO., LTD., ShenZhen City (CN)

(72) Inventor: John Gou, ShenZhen City (CN)

(73) Assignee: TERRY ELECTRONCS (S.Z) CO., LTD., ShenZhen City (CN)

(21) Appl. No.: 13/662,717

(22) Filed: Oct. 29, 2012

(51) Int. Cl. H05B 37/02

(52) U.S. Cl. CPC H05B 37/029
USPC 315/313

(57) ABSTRACT

A shoe body light-emitting device with a plurality of light-emitting forms which may include a waterproof enclosure having a cavity in which a lighting control circuit can be placed; a control circuit including a microprocessor-encapsulated circuit board and a motion actuated switch, wherein the light-emitting bodies light in a predetermined way.

### TECHNICAL FIELD

The invention relates to a shoe body light-emitting device, more particularly to a shoe body light-emitting device with a plurality of light-emitting forms.

### BACKGROUND ART

Inconvenience and danger will be caused to people going out at night if illumination at night is insufficient, e.g. kicking stones or obstacles on the road, or stepping into water, etc. Therefore, a light-emitting shoe is invented, namely, light-emitting devices are mounted on shoes to provide auxiliary illumination for people going out at night. And on festivals, wearing such light-emitting shoes can also heighten the festival atmosphere, so the light-emitting shoe is quite popular in children.

At present, the light-emitting device on common light-emitting shoes is typically composed of light-emitting diodes (LED), a driving circuit, a one shot button battery and a motion actuated switch, wherein the driving circuit is triggered by the motion actuated switch on the shoe to enable the light-emitting diodes electrically connected therewith to light. However, such a light-emitting device has only one light-emitting form and short service life, and accordingly, needs to be further improved to meet normal demands of people.

### SUMMARY OF THE INVENTION

The objective of the invention is to overcome the shortcomings in the prior art and provide a shoe body light-emitting device with a plurality of light-emitting forms; the light-emitting device can achieve light emission in multiple forms according to a preset program, thus not only providing auxiliary illumination for walking at night, but also giving colorful flashing at night to increase the walking pleasure.

Another objective of the invention is to provide a shoe body light-emitting device with longer service life.

To achieve the objectives above, the technical proposal below is adopted in the invention:

a shoe body light-emitting device with a plurality of light-emitting forms comprises:

a waterproof enclosure embedded on a shoe body, the enclosure having a cavity in which a lighting control circuit can be placed;

a control circuit embedded in the cavity of the waterproof enclosure and comprising a microprocessor-encapsulated circuit board and a motion actuated switch, the positive electrode of the circuit board being electrically coupled to the positive electrodes of a plurality of light-emitting bodies and the positive electrode of a power supply, and the motion actuated switch being electrically connected with the circuit board and being used for triggering the control circuit in response to the motion of the shoe body, so that the light-emitting bodies light in a predetermined way; and

a micro-current battery spot-welded on the circuit board and used for supplying the light-emitting device with electric power;

wherein, the predetermined way is that, the light-emitting bodies first flash N times simultaneously, then respectively flash twice sequentially, then respectively flash twice reversely, then respectively flash twice sequentially, and finally flash N times simultaneously, N is a natural number larger than or equal to 1.

Adopting the structure above, the light-emitting device of the invention can achieve light emission in multiple forms according to a preset program, can serve as an auxiliary illumination source when a wearer walks at night under poor illumination, and can increase the playing and walking pleasures at night by means of diversified light-emitting forms.

### BRIEF DESCRIPTION OF THE DRAWINGS

FIG. 1 is a structural diagram of the light-emitting device;

FIG. 2 is a structural schematic diagram of the light-emitting device;

FIG. 3 is a circuit diagram of the invention;

FIG. 4 is a diagram of a light-emitting diode and a power line in parallel connection;

FIG. 5 is a structural diagram of the light-emitting diode;

FIG. 6 is a right view of FIG. 5;

FIG. 7 is a flashing waveform view of one embodiment of the invention.

### DETAILED DESCRIPTION OF THE EMBODIMENTS

Further detailed description is made below to the invention with reference to the drawings and the embodiments.

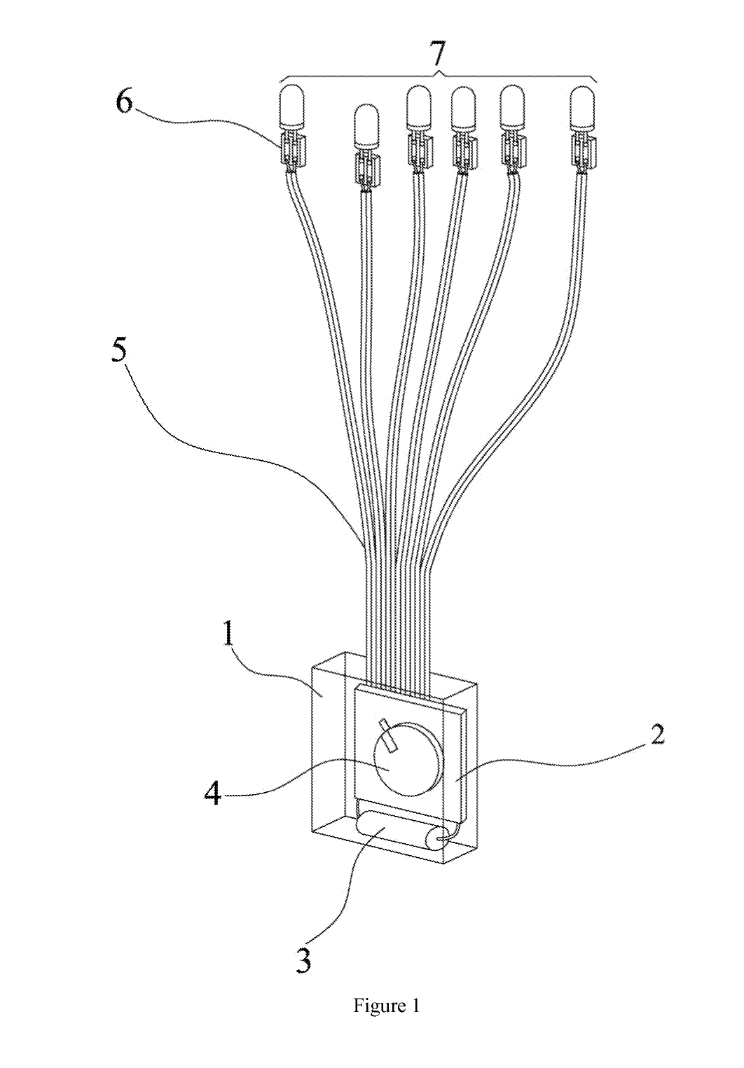

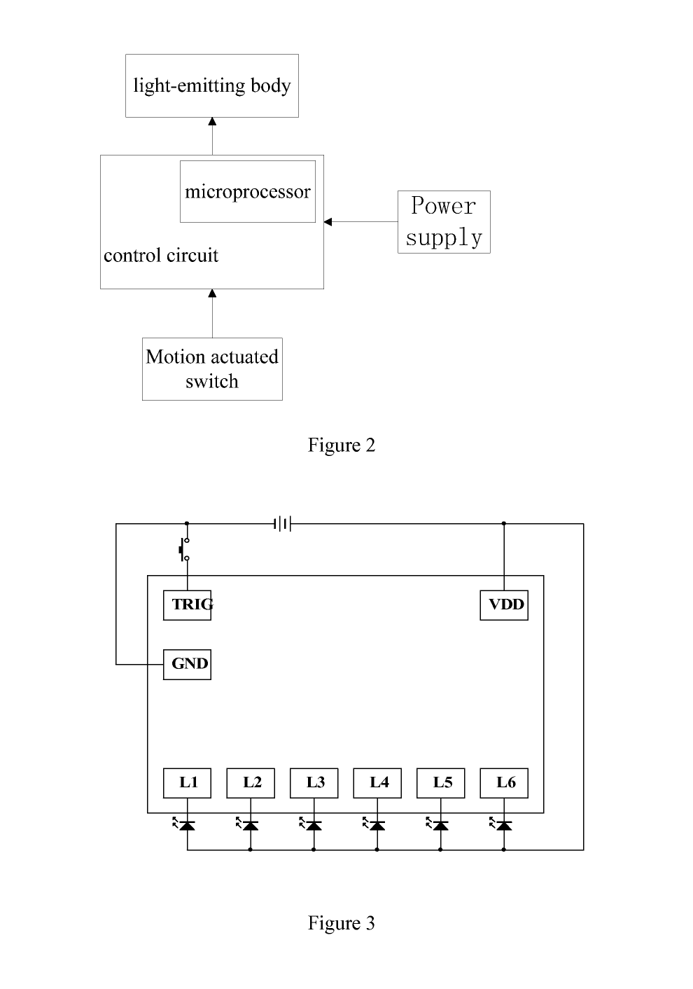

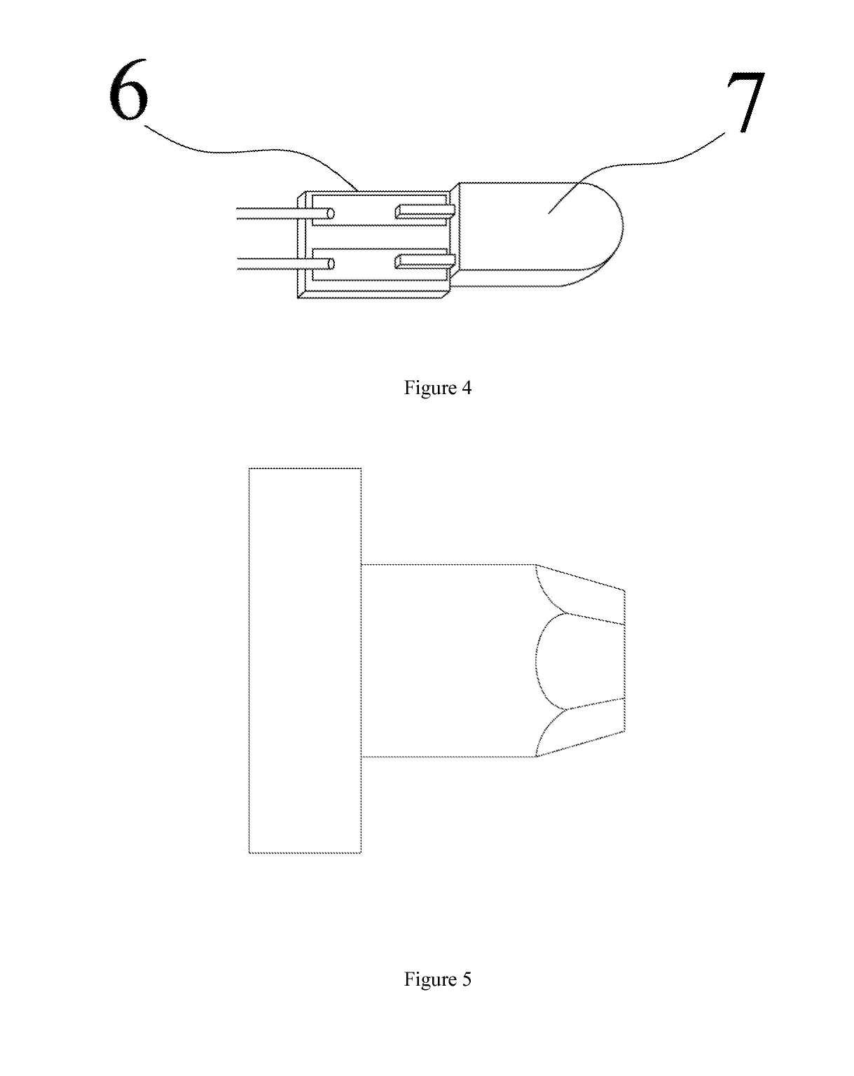

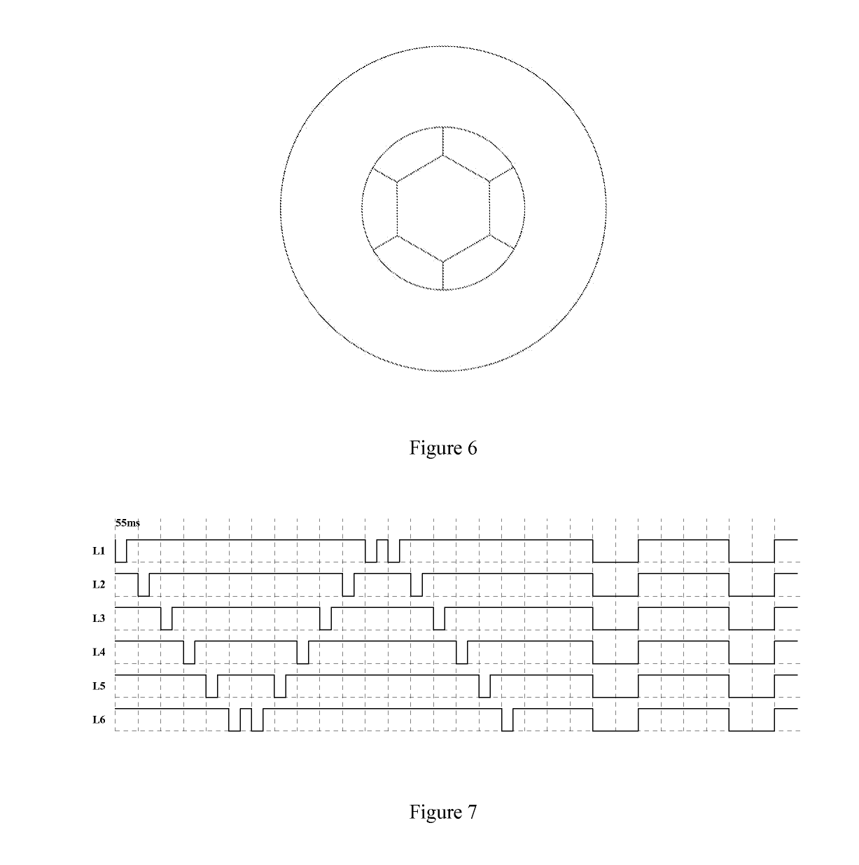

As shown by FIG. 1 to FIG. 3, a shoe body light-emitting device with a plurality of light-emitting forms comprises a waterproof enclosure 1, and the waterproof enclosure 1 has a cavity in which a control circuit can be placed.

The control circuit is embedded in the cavity of the waterproof enclosure 1 and comprises a microprocessor-encapsulated circuit board 2 and a motion actuated switch 3. The positive electrode of the circuit board 2 is electrically coupled to the positive electrodes of a plurality of light-emitting bodies 7 and the positive electrode of a power supply through power lines 5, and the motion actuated switch 3 is electrically connected with the circuit board 2 and is used for triggering the control circuit in response to the motion of the shoe body, so that the light-emitting bodies light in a predetermined way. More specifically, the positive and negative electrodes of the circuit board 2 are electrically coupled to a plurality of light-emitting bodies 7 respectively through power lines 5, and the way of electric coupling is that one end of the power line 5 is welded to the corresponding electrode of the circuit board 2 of the control circuit, while the other end is welded to the corresponding electrode of the circuit board 6 of the light-emitting body 7, and fixation is accomplished by hot-melt adhesive. In partial special circuits, the top end of each of the light-emitting diodes is a square hexagonal plane, and the side surface of each of the light-emitting diodes is composed of six polygons. A micro-current lithium-manganese button battery 4 is welded on the circuit board 2, and electric power is supplied to the control circuit in the form of micro current by the improved lithium-manganese button battery 4.

The predetermined way is that, the light-emitting bodies 7 first flash N times simultaneously, then respectively flash twice sequentially, then respectively flash twice reversely, then respectively flash twice sequentially, and finally flash N times simultaneously. Specifically, six LED light-emitting diodes 7 first flash once simultaneously, then respectively flash twice sequentially (L1-L1, L2-L2, L3-L3, L4-L4, L5-L5, L6-L6), then respectively flash twice reversely (L6-L6, L5-L5, L4-L4, L3-L3, L2-L2, L1-L1), then respectively flash twice sequentially (L1-L1, L2-L2, L3-L3, L4-L4, L5-L5, L6-L6), and finally flash twice simultaneously.

As a second embodiment of the invention, the predetermined way is that, the light-emitting bodies 7 first light once sequentially at intervals, then light once reversely at intervals, then light once sequentially at intervals of 10 to 15 milliseconds, and then flash N times simultaneously, N is a natural number larger than or equal to 1. FIG. 7 shows a waveform view of the light-emitting forms of the light-emitting bodies 7, and specifically, the light-emitting bodies light in a sequence of L1-L2-L3-L4-L5-L6 at intervals of 10 to 15 milliseconds, then light in a reversed sequence of L6-L5-L4-L3-L2-L1 at intervals of 10 to 15 milliseconds, then light in a sequence of L1-L2-L3-L4-L5-L6 at intervals of 10 to 15 milliseconds, and finally flash twice simultaneously.

As a third embodiment of the invention, the predetermined way is that, six light-emitting bodies 7 sequentially light N times when triggered N times by the motion actuated switch, and in the case of N+1 triggering, three of the light-emitting bodies light sequentially, then simultaneously flash pairwise, and finally all flash simultaneously, N is a natural number larger than or equal to 1. Specifically, the light-emitting bodies light in a sequence of L1-L2-L3-L4-L5-L6 when triggered by the motion actuated switch, triggering four times enables the light-emitting bodies to sequentially light four times, and at the time of fifth triggering, the light-emitting bodies L4-L5-L6 light sequentially, afterwards, the light-emitting bodies L4 and L5 flash simultaneously, then the light-emitting bodies L4 and L6 flash simultaneously and the light-emitting bodies L5 and L6 flash simultaneously, and finally, the light-emitting bodies L4, L5, L6 flash simultaneously.

As a fourth embodiment of the invention, the predetermined way is that, six light-emitting bodies 7 L1 to L6 respectively light twice when triggered by the motion actuated switch, and after triggering N times, three light-emitting bodies sequentially light when being triggered N+1 times, then simultaneously flash pairwise, and finally all flash simultaneously, N is a natural number larger than or equal to 1. Specifically, after L1-L1, L2-L2, L3-L3, L4-L4, L5-L5 and L6-L6 respectively light three times, the light-emitting bodies L4-L5-L6 sequentially light during fourth lighting, afterwards, the light-emitting bodies L4 and L5 flash simultaneously, then the light-emitting bodies L4 and L6 flash simultaneously and the light-emitting bodies L5 and L6 flash simultaneously, and finally, the light-emitting bodies L4, L5, L6 flash simultaneously.

What is claimed is:

1. A shoe body light-emitting device with a plurality of light-emitting forms, which comprises: a waterproof enclosure embedded on a shoe body, the enclosure having a cavity in which a lighting control circuit can be placed;
a control circuit embedded in the cavity of the waterproof enclosure and comprising a microprocessor-encapsulated circuit board and a motion actuated switch, the positive electrode of the circuit board being electrically coupled to the positive electrodes of a plurality of light-emitting bodies and the positive electrode of a power supply, and the motion actuated switch being electrically connected with the circuit board and being used for triggering the control circuit in response to the motion of the shoe body, so that the light-emitting bodies light in a predetermined way; and a micro-current battery spot-welded on the circuit board and used for supplying the light-emitting device with electric power;
wherein the predetermined way is that, the light-emitting bodies first flash N times simultaneously, then respectively flash twice sequentially, then respectively flash twice reversely, then respectively flash twice sequentially, and finally flash N times simultaneously, N is a natural number larger than or equal to 1.

2. The light-emitting device according to claim 1, wherein the positive and negative electrodes of the circuit board are electrically coupled to a plurality of light-emitting bodies respectively through power lines, and the way of electric coupling is that one end of the power line is welded to the corresponding electrode of the circuit board of the control circuit, while the other end is welded to the corresponding electrode of the circuit board of the light-emitting body.

3. The light-emitting device according to claim 2, wherein the lamp wires of the light-emitting bodies are connected in parallel, the electrode pins of the light-emitting bodies are cut short and then welded on the circuit boards of the light-emitting bodies, and simultaneously, power lines are welded on the corresponding electrodes of the circuit boards, and the welding spots are reinforced and insulated by hot-melt adhesive.

4. The light-emitting device according to claim 1, wherein the plurality of light-emitting bodies at least include 6 light-emitting diodes, the top end of each of the light-emitting diodes is a square hexagonal plane, and the side surface of each of the light-emitting diodes is composed of six polygons.

5. A shoe body light-emitting device with a plurality of light-emitting forms, which comprises:
a waterproof enclosure embedded on a shoe body, the enclosure having a cavity in which a lighting control circuit can be placed;
a control circuit embedded in the cavity of the waterproof enclosure and comprising a microprocessor-encapsulated circuit board and a motion actuated switch, the positive electrode of the circuit board being electrically coupled to the positive electrodes of a plurality of light-emitting bodies and the positive electrode of a power supply, and the motion actuated switch being electrically connected with the circuit board and being used for triggering the control circuit in response to the motion of the shoe body, so that the light-emitting bodies light in a predetermined way; and
a micro-current battery spot-welded on the circuit board and used for supplying the light-emitting device with electric power;
wherein the predetermined way is that, the light-emitting bodies first light once sequentially at intervals, then light once reversely at intervals, then light once sequentially at intervals of 10 to 15 milliseconds, and then flash N times simultaneously, N is a natural number larger than or equal to 1.

6. The light-emitting device according to claim 5, wherein the positive and negative electrodes of the circuit board are electrically coupled to a plurality of light-emitting bodies respectively through power lines, and the way of electric coupling is that one end of the power line is welded to the corresponding electrode of the circuit board of the control circuit, while the other end is welded to the corresponding electrode of the circuit board of the light-emitting body.

7. The light-emitting device according to claim 6, wherein the lamp wires of the light-emitting bodies are connected in parallel, the electrode pins of the light-emitting bodies are cut short and then welded on the circuit boards of the light-emitting bodies, and simultaneously, power lines are welded on the corresponding electrodes of the circuit boards, and the welding spots are reinforced and insulated by hot-melt adhesive.

8. The light-emitting device according to claim 5, wherein the plurality of light-emitting bodies at least include 6 light-emitting diodes, the top end of each of the light-emitting diodes is a square hexagonal plane, and the side surface of each of the light-emitting diodes is composed of six polygons.

9. A shoe body light-emitting device with a plurality of light-emitting forms, which comprises:
a waterproof enclosure embedded on a shoe body, the enclosure having a cavity in which a lighting control circuit can be placed;
a control circuit embedded in the cavity of the waterproof enclosure and comprising a microprocessor-encapsulated circuit board and a motion actuated switch, the positive electrode of the circuit board being electrically coupled to the positive electrodes of a plurality of light-emitting bodies and the positive electrode of a power supply, and the motion actuated switch being electrically connected with the circuit board and being used for triggering the control circuit in response to the motion of the shoe body, so that the light-emitting bodies light in a predetermined way; and
a micro-current battery spot-welded on the circuit board and used for supplying the light-emitting device with electric power;
wherein the predetermined way is that, the light-emitting bodies sequentially light N times when triggered N times by the motion actuated switch, and in the case of N+1 triggering, three of the light-emitting bodies light sequentially, then simultaneously flash pairwise, and finally all flash simultaneously, N is a natural number larger than or equal to 1.

10. The light-emitting device according to claim 9, wherein the positive and negative electrodes of the circuit board are electrically coupled to a plurality of light-emitting bodies respectively through power lines, and the way of electric coupling is that one end of the power line is welded to the corresponding electrode of the circuit board of the control circuit, while the other end is welded to the corresponding electrode of the circuit board of the light-emitting body.

11. The light-emitting device according to claim 10, wherein the lamp wires of the light-emitting bodies are connected in parallel, the electrode pins of the light-emitting bodies are cut short and then welded on the circuit boards of the light-emitting bodies, and simultaneously, power lines are welded on the corresponding electrodes of the circuit boards, and the welding spots are reinforced and insulated by hot-melt adhesive.

12. The light-emitting device according to claim 5, wherein the plurality of light-emitting bodies at least include 6 light-emitting diodes, the top end of each of the light-emitting diodes is a square hexagonal plane, and the side surface of each of the light-emitting diodes is composed of six polygons.
